(19) United States
(12) Patent Application Publication
(10) Pub. No.: US 2026/0115912 A1
(43) Pub. Date: Apr. 30, 2026

(54) Method and Apparatus for Robot Trajectory Planning

(71) Applicant: ABB Schweiz AG, Baden (CH)

(72) Inventors: Arne Wahrburg, Weiterstadt (DE); Mattias Bjorkman, Västerås (SE); Giacomo Spampinato, Västerås (SE); Mikael Norrlof, Norrköping (SE); Nima Enayati, Mannheim (DE); Jonas Haulin, Shanghai (CN); Debora Clever, Zwingenberg (DE)

(73) Assignee: ABB Schweiz AG, Baden (CH)

(21) Appl. No.: 18/695,952

(22) PCT Filed: Sep. 27, 2021
(86) PCT No.: PCT/EP2021/076499

§ 371 Date: Nov. 5, 2024

(51) Int. Cl. B25J 9/16; G05D 1/646

(52) U.S. Cl. CPC B25J 9/1664; G05D 1/646

(57) ABSTRACT

A method for defining a trajectory of a robot (1) for moving along a path from an initial point (A) to a final point (B) in a multidimensional space, each of whose points has a plurality of space coordinates, which are position and/or orientation coordinates, wherein the trajectory is a continuous map mapping an initial instant in time to the initial point (A), a final instant to the final point (B) and intermediate instants to intermediate points of the path, comprises the steps of defining (S3) a cost function which associates a cost value to a given trajectory, defining (S3) a pluridimensional subspace of said multidimensional space and determining (S4) among trajectories extending along different paths of said subspace, a trajectory which minimizes the cost function.

### FIELD OF THE DISCLOSURE

The present invention relates to a method and to apparatus for planning a trajectory for movement of a robotic unit.

### BACKGROUND OF THE INVENTION

Conventionally, trajectory planning for a robotic unit has been done by a programmer defining a path to be followed by the robotic unit, and an electronic controller deriving from the path a trajectory by associating to each point of the path an instant in time when the robotic unit shall be located at that point, in a way to minimize the time or the energy spent on the path. In the simplest of cases, initial and final points of a path may be predetermined, e.g. by the requirement that tool or a workpiece has to be taken up at the initial point and to be transported to the final point for subjecting it to a working process there, and the definition work to be done by the programmer can be merely to decide whether to allow the robotic unit to move along a straight path (or some other default path) or, if for some reason the default path is not practical, to choose some intermediate point and to repeat the procedure for both a path from the initial point to the intermediate point, and a path from the intermediate point to the final point. In either case, time or energy consumption cannot be expected to be optimal.

While the decision that it is necessary to define an intermediate point may be easy if the default path would cause the robotic unit to collide with an obstacle, and choosing an intermediate point so that the obstacle can be avoided may be straightforward, judging whether efficiency of the robot might be improved by such a measure is not, and a lot of programmer's working time can be spent in the effort.

The object of the present invention is, therefore, to facilitate finding an efficient trajectory.

The object is achieved by a method for defining a trajectory of a robotic unit for moving along a path from an initial point to a final point in a multidimensional space, each of whose points has a plurality of space coordinates, which are position and/or orientation coordinates, wherein the trajectory is a continuous map mapping an initial instant in time to the initial point, a final instant to the final point and intermediate instants to intermediate points of the path, the method comprising the steps of defining a cost function which associates a cost value to a given trajectory, defining a pluridimensional subspace of said multidimensional space and determining among trajectories extending along different paths of said subspace, a trajectory which minimizes the cost function.

While in the conventional approach, when a path is determined beforehand, and the robotic unit is assumed to proceed along the path, each point of the path is assigned an instant in time when the robotic unit will actually be located at said point, and all that can actually be optimized is the speed with which the robotic unit proceeds along the path. However, when the point of view is reversed, assuming that the robotic unit proceeds in time from the initial instant at which it is located at the initial point, to the final instant at which it is located at the final point, points from all over the subspace can be assigned to each instant, leading to a much greater freedom of optimization.

Evidently, the greatest freedom of optimization is achieved when the subspace is the multidimensional space, and no limitations at all are imposed on the choice of points that will be involved in the trajectory.

On the other hand, it may be appropriate to consider a subspace whose number of dimensions is indeed smaller than that of the multidimensional space in order to reduce the calculation time involved. This can be done without reducing the quality of the optimization if it is known beforehand that e.g. a certain coordinate is irrelevant. E.g. when the robotic unit is handling a rotary tool or a rotation symmetric workpiece, the subspace may lack an orientation coordinate dimension associated to the axis of the tool or the workpiece.

In a practical embodiment, the multidimensional space can have two position coordinates and, optionally, an orientation coordinate, and the robotic unit may comprise a vehicle which displaceable in two directions on a surface and to perform a yawing movement by an axis perpendicular to said surface. Alternatively, the multidimensional space can have three position coordinates and, optionally, up to three orientation coordinates, in which case the robotic unit may comprise an end effector, preferably associated to a gantry or to an articulated robot arm.

The cost function can be an increasing function of a time derivative of at least one of the space coordinates of the trajectory. The derivative can be first order, i.e. a linear or angular speed, second order, i.e. an acceleration, or third order, i.e. a jerk. In either case, the fact that high values of the derivative lead to a high cost will cause the optimization to avoid trajectories having such high values, and will thus reduce wear and improve reliability of the robotic unit. Additionally or alternatively, the cost function can be an increasing function of a difference between maximum and minimum values assumed by a given coordinate along the given trajectory. A cost function which penalizes large differences between maximum and minimum values of a coordinate will induce the method to shun unnecessarily far-flung movements. A thus optimized trajectory will also involve low speeds so that wear and energy consumption can be expected to be low.

In order to ensure that the trajectory will fulfill predetermined user requirements, the step of determining the trajectory which minimizes the cost function can carried out under a constraint that reflects the requirement.

The constraint may impose a condition for a time derivative of at least one of the space coordinates, preferably for a speed, an acceleration or a jerk. In that way, e.g. technical limitations of the robot can be taken into account.

In most practical cases, the condition imposed will be an upper limit for said time derivative. By such a condition it can be ensured that the trajectory will not involve a speed or an acceleration exceeding the capacity of the robotic unit.

In a preferred embodiment, the upper limit is selected irrespective of the capacity of the robotic unit, namely so as to keep the amount of energy transferred when the robotic unit, while executing the planned trajectory, collides with a person at rest, at a level deemed to bear no risk of injury to the person. In practice, the requirement that the amount of energy transferred shall not exceed a given threshold can be implemented in different ways, depending on the degree of sophistication and on assumptions about the environment. It can be assumed, e.g., that the collision is fully inelastic, and that the person might be unable to recede, possibly being caught between the robot and a wall. In that case it may be necessary to assume that the entire kinetic energy of the robot will be transferred to the person and must therefore not exceed the threshold, and to set a speed limit for the robotic unit accordingly, considering its inertia. If it is certain that the person will be able to move away from the robot, the amount of energy transferred may be calculated assuming that after collision—and before the robotic unit can be decelerated—it and the person will be moving with a same speed determined by the law of conservation of momentum. It would also be conceivable to set the energy threshold taking into account the height above ground of the robotic unit and the vulnerability of body parts of a person the robotic unit might hit at that height.

The risk of injury is not related to the transfer of energy alone: pressure can be sufficient to cause injury or pain, even if the energy transferred is negligible. Therefore, a further constraint taken account of in the minimization of the cost function should limit a pressing force exercised on a surface by the robotic unit.

According to another embodiment, the condition imposed may be a relation between the orientation of the robotic unit and the direction of a vector of time derivatives, in particular that the vector is perpendicular to a surface of the robotic unit. In such a case, workpieces can be placed on that surface, similar to objects on a tray, without any kind of lateral fixture, and will remain standing on the surface when the robotic unit moves. This would allow to convey a plurality of workpieces much more efficiently than by seizing and moving them one after the other by a gripper-type robotic unit.

According to still another embodiment, the condition imposed may be an upper limit for a load imposed on an actuator driving movement of the robotic unit along the trajectory. By limiting the load, premature wear of the robotic unit can be avoided.

A reduction of wear can also be achieved by defining the cost function to be an increasing function of a load imposed on an actuator driving movement of the robotic unit along the trajectory. While the constraint mentioned above will safely prevent any load exceeding the limit, but will freely allow the load to come close to the threshold over substantial parts of the trajectory, the cost function will minimize the load over the entire trajectory, but will allow a high load to occur if there is no other way for the robotic unit to reach the final point.

The above object of the invention is also achieved by a robotic system comprising a robotic unit and a motion controller adapted to carry out the method described above, or by a computer program product which, when executed on a computer, enables the computer to carry out the method.

Further features and advantages of the invention will become apparent from the subsequent description of embodiments thereof, referring to the appended drawings.

### BRIEF DESCRIPTION OF THE SEVERAL VIEWS OF THE DRAWINGS

FIG. 1 is a diagram of a robot system in which the invention can be implemented; and

FIG. 2 illustrates the structure of a robot control program.

### DETAILED DESCRIPTION OF THE INVENTION

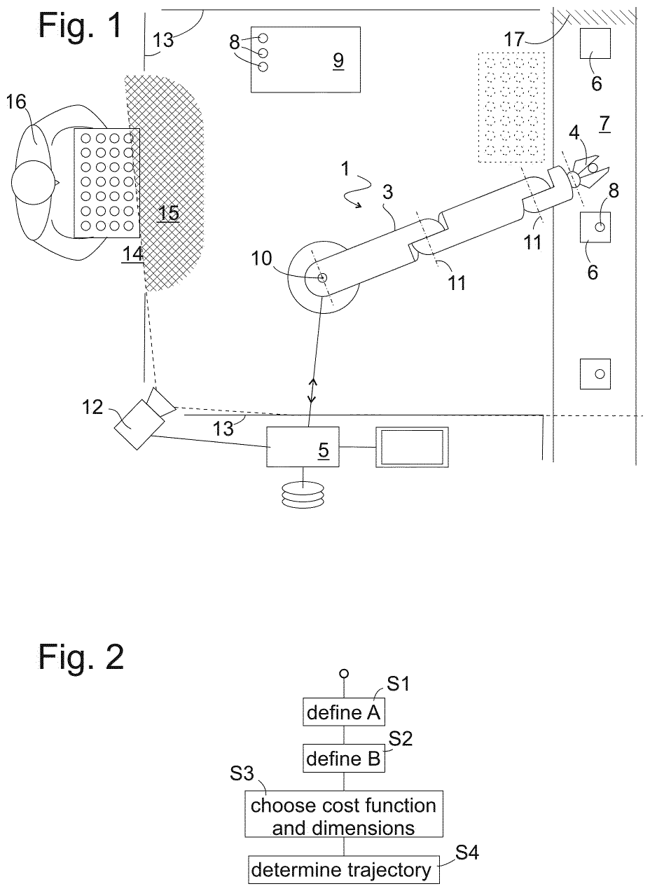

FIG. 1 is a schematic plan view of an industrial robot 1 and its working environment. In the embodiment shown here, the robot 1 has a stationary base 2, at least one articulated arm 3 having a proximal end connected to base 2, and an end effector 4 at a distal end of the arm 3, but it should be kept in mind that the method which will be described subsequently is also applicable to other types of robots, such as a gantry type robot, mobile robots etc.

The motion of the robot 1 is controlled by an operation controller 5, typically a microcomputer, in order to carry out a predefined manufacturing task, for example combining each of a series of first workpieces 6, supplied by a conveyor 7, with a second workpiece 8, taken from a tray 9. In the tray 9, a regular arrangement of workpieces 8, with spaces between them, facilitates seizing of the workpieces 8 by end effector 4. In a first embodiment of the invention, it will be assumed that the conveyor 7 stops when necessary, so that a workpiece 6 will be at rest when the robot 1 combines a workpiece 8 to it.

Operation controller 5 is connected to internal sensors of robot 1, in order to receive from these data relating to angles of all joints 11 of the robot 1, to electrical power absorbed by motors of the robot 1, etc., that enable the operation controller 5 to calculate a current pose of the robot 1 and velocities of its various components.

The operation controller 5 is further connected to a spatially resolving sensor 12, typically an electronic camera, which is designed and positioned to monitor the robot 1 and its vicinity, and in particular to detect positions and orientations of the workpieces 6, 8. In FIG. 1, the sensor 12 is represented as a single camera. In practice it may comprise several cameras monitoring the tray 9, the conveyor 7 and other regions of the working environment.

Based on output from sensor 12, motion planner 5 identifies, in step S1 of the method shown in FIG. 2, a next workpiece 8 to be seized from tray 9, and determines, based on this identification, a pose A of the end effector 4 in which seizing the workpiece 8 is possible. In case of the end effector 4 being displaceable in three degrees of freedom of translation and three of rotation, the pose A is defined by three position coordinates and three angular coordinates in a coordinate system in which the base 2 is stationary.

In a next step S2, motion planner 5 determines a pose B in which the robot 1 can combine the previously seized workpiece 8 with a workpiece 6 on conveyor 7. This can be done after conveyor 7 has been stopped: preferably it is done by the motion planner 5 determining, based on input from sensor 12, coordinates of workpiece 8 in the direction of displacement of conveyor 7 and in the transversal direction thereof, selects a position of the workpiece 6 in the direction of displacement where the workpiece 6 would be convenient to handle.

So, poses A and B can be regarded as points in a six-dimensional space, and a path C along which the end effector 4 is moved from A to B is a one-dimensional subspace thereof, i.e. along which all six coordinates gradually change from A to B. A trajectory maps every point of the path C to an instant in time when the end effector 4 is located at that point. An instant Tⱼ when the end effector starts moving from initial point A can be defined as t=0. An instant T_{f} when it shall reach final point B can be predetermined in seconds or some other appropriate unit of time, or it can simply be defined to be T_{f}=Tᵢ+1 in some arbitrary unit of time.

In order to define a trajectory which the end effector 4 shall follow from A to B, an optimization problem must be solved. The problem may be written in different ways, depending on how a state vector of the system is defined and what is regarded as an input to the system. In a first representation, a state vector is formed by concatenating a pose vector x₁, the components of which define position and orientation of end effector 4, and a speed vector x₂ whose components are the time derivatives of the components of x₁, torque u is regarded as an input into the system, which causes a change if the state vector. Here, the problem can be written

$$minimize \tilde{ℒ} , s . t . \qquad ( 1 )$$

$${x}_{1} , {x}_{2} , u$$

$${\dot{x}}_{1} = {x}_{2} ,$$

$${\dot{x}}_{2} = {M ( {x}_{1} )}^{- 1} ( - C ( {x}_{1} , {x}_{2} ) - G ( {x}_{1} ) - {τ}_{fric} ( {x}_{2} ) + u ) ,$$

$${q}_{min} \leq {x}_{1} \leq {q}_{max} ,$$

$$- {\dot{q}}_{max} \leq {x}_{2} \leq {\dot{q}}_{max} ,$$

$$- {τ}_{max} ( {x}_{2} ) \leq u \leq {τ}_{max} ( {x}_{2} ) .$$

$$\frac{1}{2} \frac{{m}_{body} {m}_{eff}}{{m}_{body} + {m}_{eff}} {v}_{rel}^{2} \leq {E}_{limit} \qquad ( {1}^{′} )$$

Here [symbol] is a cost function to be minimized, the first constraint defines that the speed x₂ is the time derivative of x₁, as mentioned above, the second corresponds to the equation of motion for rigid bodies, where M, C, and G, represent the mass matrix, Coriolis and centrifugal torques and gravity torques respectively, the third and fourth introduce are limitations of coordinates and their derivatives imposed by design limitations of the robot, and the fifth imposes a limit on input u which may depend on the configuration of the robot. The last constraint (1′) imposes a limit for energy transfer to a person in case of a collision with the end effector 4, m_{body} being the mass of the human body region involved in the collision, m_{eff} the effective mass of the robot 1 and vᵣₑₗ the relative speed of the robot and the body region prior to the collision. Eₗᵢₘᵢₜ can take the values specified in DIN ISO/TS 15066 for different body regions. For the above inequality it has been assumed that after collision both the body region and the robot will move with the same speed, and that the speed of the body region has changed by vᵣₑₗ.

It should be noted that although the quantity for which a limit is explicitly specified in constraint (1′) is kinetic energy of the robot, the constraint is equivalent to a limitation of contact force: if the human body is modeled as a spring having spring constant k, the contact force between the robot and the body is at maximum when the kinetic energy of the robot has been converted completely into elastic energy of the spring. In that case,

$$E = \frac{{F}_{max}^{2}}{2 k}$$

holds, i.e. constraint (1′) can be replaced by an equivalent constraint for contact force:

$$\frac{1}{2} \frac{{m}_{body} {m}_{eff}}{{m}_{body} + {m}_{eff}} {v}_{rel}^{2} \leq \frac{{F}_{max}^{2}}{2 k} \qquad ( 2 )$$

In step S3, a cost function for the optimization problem is chosen. Points A and B having been defined before, choice of the cost function can be made dependent on what is done at these points: else the step of choosing the cost function might be carried out before steps S1 and S2. The cost function can be chosen in step S3 as

$$ℒ = {\int }_{{T}_{i}}^{{T}_{f}} {\dot{x}}_{2}^{T} R {\dot{x}}_{2} dt \qquad ( 3 )$$

Where

$${\dot{x}}_{2}^{T} R {\dot{x}}_{2}$$

is a measure of driving power consumed for the movement. Other terms might be added to the cost function in order to make the trajectory that minimizes the cost function meet other criteria.

One such term may be the duration of the trajectory, T_{f}−Tᵢ:

$$ℒ = ( {T}_{f} - {T}_{i} ) + {μ}_{1} {\int }_{{T}_{i}}^{{T}_{f}} {\dot{x}}_{2}^{T} R {\dot{x}}_{2} dt \qquad ( {3}^{′} )$$

I.e. this cost function is an increasing function of duration and of energy consumption, and a trajectory that minimizes this cost function will be a compromise between the requirements of limiting duration and energy consumption, the relative weight of the two criteria being represented by the weighting factor μ. Other terms might be added to the cost function in order to make the trajectory that minimizes the cost function meet other criteria. An alternative cost function (or an additional term in one of the above cost functions [symbol] can be

$$ℒ = ( {T}_{f} - {T}_{i} ) + {μ}_{2} {\int }_{{T}_{i}}^{{T}_{f}} {\ddot{x}}_{2}^{T} Q {\ddot{x}}_{2} dt \qquad ( 4 )$$

where

$${\ddot{x}}_{2}^{T} Q {\ddot{x}}_{2}$$

is a measure of jerk occurring in the movement, l.e. this cost function is an increasing function of total change of acceleration, and the effect of using the cost function (or another cost function comprising a term proportional to

$${\int }_{{T}_{i}}^{{T}_{f}} {\ddot{x}}_{2}^{T} Q {\ddot{x}}_{2} dt$$

is to encourage “smoother” trajectories.

This is preferable for articulated manipulators as it reduces the excitation of flexible structural modes: i.e. optimization based on this cost function can be expected to result in a trajectory which, by avoiding strong vibrations, will reduce wear of the robot. Another alternative cost function can be.

$$ℒ = ( {T}_{f} - {T}_{i} ) + {μ}_{3} {\sum }_{j = 1}^{{N}_{D 0 F}} \vert {max}_{[ {T}_{i} , {T}_{f} ]} ( {x}_{1 , j} ) - {min}_{[ {T}_{i} , {T}_{f} ]} ( {x}_{1 , j} ) \vert \qquad ( 5 )$$

where max, min denotes a maximum and a minimum of a given coordinate x_{1,j} of the pose vector x₁ in the course of the trajectory of the robot, and Σ denotes a sum over all degrees of freedom j=, . . . , N_{DOF} of the robot. By thus penalizing large changes of any coordinate x₁ of the robot, this cost function favors a trajectory which allows the robot to move from A to B while minimizing the range in which coordinates of the robot change on the way. However, the second summand would be the same regardless of whether the coordinate changes between min (x_{1,k}) and max (x_{1,k}) just once or multiple times. I.e. an oscillating movement of the robot would be penalized by the above cost function only when it causes the duration T_{f}Tᵢ of the robot's movement to increase.

A preferred cost function, which is certain to avoid unnecessary oscillating movements of the robot, is

$$ℒ = ( {T}_{f} - {T}_{i} ) + {μ}_{4} {\sum }_{k = 2}^{M} {( {x}_{1}^{k} - {x}_{1}^{k - 1} )}^{T} P ( {x}_{1}^{k} - {x}_{1}^{k - 1} ) , \qquad ( 6 )$$

wherein M is a number of steps into which the trajectory is decomposed, the vector difference

$${x}_{1}^{k} - {x}_{1}^{k - 1}$$

stands for the change of pose vector x₁ in step k, i.e. between an instant at the end of the present step k and an instant at the end of the previous step (k−1), and P is a weighting matrix. P may be a diagonal matrix. Each diagonal coefficient of the matrix is associated to one degree of freedom of the robot and its respective joint: its numerical value may reflect the power required for moving that joint. Generally, this power will be the higher, the greater the mass to be moved by the joint in question is, i.e. the coefficient will be the higher, the closer to base 2 the joint is. Minimizing cost function (6) will thus yield a trajectory in which not only the interval in which a particular coordinate component x_{1,k} varies along a trajectory is minimized, but the accumulated change of the coordinate components is, i.e. it will find a shortest trajectory which, due to the small amount of movement of the robot's joints involved, can be expected to be energy-efficient and cause little wear.

Other terms might be added to the cost function in order to make the trajectory that minimizes the cost function meet other criteria.

One such additional term might be μ₂∫u^{T}Qᵤu: This term penalizes trajectory portions where a high torque must be applied by the actuators of the robot, be it for accelerating, or for overcoming a non-inertia related resistance, in particular for lifting a heavy workpiece. It should be noted in this context that the fourth constraint of eq. (1) above already ensures that motion planner 5 will never plan a trajectory that would require a torque u to be applied which exceeds the physical limitations ±τₘₐₓ(x₂) of the robot. In practice, trajectories requiring high torque are also penalized by cost function (3), either because

$${\dot{x}}_{2}^{T} R {\dot{x}}_{2}$$

is high when high torque causes high acceleration \dot{x}₂, or by lengthening the integration period when the high torque is needed to overcome non-inertia related resistance such as a heavy weight of a workpiece, and the movement of the robot can only proceed slowly.

The result of such cost function minimization by optimizing not only the speed on a predetermined path from A to B, but by optimizing the trajectory, will be that the motion planner 5 tends to prefer trajectories that have a convex curvature on their side facing the robot base 2: By drawing the workpiece close to the base, the torque applied to the robot's joints by the workpiece is reduced: therefore a trajectory where most of the workpiece raising and lowering work is done with the workpiece held close to the base tends to be preferred over a straight one.

Instead of torque, acceleration can be considered as the system input (u=\ddot{q}), resulting in the problem being written as

$$\begin{matrix}minimize \\ {x}_{1} , {x}_{2} , u\end{matrix} {T}_{f} + μ {\int }_{0}^{{T}_{f}} {\dot{u}}^{T} Q \dot{u} , s . t .$$

$${\dot{x}}_{1} = {x}_{2} ,$$

$${\dot{x}}_{2} = u ,$$

$${q}_{min} \leq {x}_{1} \leq {q}_{max} ,$$

$$- {\dot{q}}_{max} \leq {x}_{2} \leq {\dot{q}}_{max} ,$$

$$- {τ}_{max} ( {x}_{2} ) \leq M ( {x}_{1} ) u + C ( {x}_{1} , {x}_{2} ) + G ( {x}_{1} ) + {τ}_{fric} ( {x}_{2} ) \leq {τ}_{max} ( {x}_{2} ) .$$

$$\frac{1}{2} \frac{{m}_{body} {m}_{eff}}{{m}_{body} + {m}_{eff}} {v}_{rel}^{2} \leq {E}_{limit}$$

It is readily apparent that the two sets of equations are equivalent, and that the minimization will yield identical trajectories for both. The constraint (1′) can be combined with or replaced by other constraints, depending on the intended application of the robot system.

One such constraint can be imposed in order to minimize fluctuation of the direction of acceleration to which an object is subject while being handled by the robot 1. E.g, in FIG. 1 the position of the tray is quite close to an opening 14 in a wall 13 which delimits the working embodiment of the robot 1, so that a person 16, when walking in and replacing the tray, will not interfere unnecessarily with the movement of the robot. On the other hand, this causes the tray to be quite far away from the conveyor 7, so that the robot has to move quite far for each workpiece 8 it seizes from the tray. The robot would be able to work faster if the tray 9 was placed closer to the conveyor 7, but while the person 16 walked in far enough to place it there, freedom of movement of the robot 1 would be strongly impaired. It would therefore be very convenient if the robot 1 could take over the tray 9 from the person in a region close to opening 14, e.g. cross-hatched region 15 in FIG. 1, place the tray 9 conveniently close to conveyor 7, and then process the workpieces 8 on it one after the other. In that case, acceleration of the tray 9 and the workpieces 8 on it must be controlled so that when the robot 1 moves the tray 9, workpieces 8 will not fall off and, preferably will not tip over and will stay spaced from each other, so that when the tray has been put down, the workpieces 8 are easy for the robot to seize. This can be achieved by the robot 1 tilting the tray 9 so that the sum f_{wp} of gravity g and inertial forces acting on each workpiece 8 is always close enough to the surface normal of the tray: when \ddot{x}_{rob} denotes the acceleration of the robot end effector 4 in a reference frame where the robot base 2 is at rest,

$${f}_{WP} = - m {\ddot{x}}_{WP} = - m ( {\ddot{x}}_{rob} + g )$$

This force can be decomposed into a component parallel to the surface normal n of the tray 9:

$${f}_{WP}^{n} = ( {n}^{T} \cdot {f}_{WP} ) n$$

and perpendicular thereto:

$${f}_{WP}^{t} = {f}_{WP} - {f}_{WP}^{n}$$

The requirement that workpieces shall not slide translates into

$$‖ {f}_{WP}^{t} ‖ \leq μ ‖ {f}_{WP}^{n} ‖ \qquad ( 7 )$$

wherein μ denotes the friction coefficient of the workpieces on the tray surface. The above expression can be simplified to

$${{f}_{WP}^{t}}^{T} \cdot {f}_{WP}^{t} \leq {( μ {n}^{T} \cdot {f}_{WP}^{n} )}^{2} \qquad ( 8 )$$

By planning a trajectory for the tray under this constraint (7) or (8), sliding of workpieces on the tray can be avoided.

Tipping over of workpieces can be prevented by imposing a mathematically similar constraint: it is sufficient to replace the friction coefficient μ in above eq. (7) or (8) by a coefficient, dependent on the shape of the workpiece, that limits the surface parallel force component

$${f}_{WP}^{t}$$

so that the force vector f_{WP} having for origin the center of mass of a workpiece, will intersect the tray surface inside the base area on which that workpiece rests.

The pose of the end effector 4 at any given instant in time can be regarded as a six-dimensional vector, with three components defining the location of the end effector 3 in three-dimensional space, and another three defining its orientation, or with components associated to angles of rotation of the robot's joints 10,11. The optimization can be carried out in all these dimensions. Otherwise, ad-hoc constraints can be used to reduce the complexity of the cost function minimization problem. If e.g. the distance between A and B is short enough to be covered by a movement of distal joints 11 of the robot alone, it is a good guess that the most efficient trajectory from A to B is one in which the most proximal joint 10 of the robot moves very little or not at all. In that case, adding a constraint that the coordinate of the most proximal joint 10 shall be constant will reduce the number of dimensions of the space to be searched for the optimal trajectory by one (or two, if the most proximal joint 10 is a ball joint), and can therefore be expected to reduce substantially the amount of calculation required while still yielding the most efficient or very nearly most efficient trajectory.

When the cost function and the vector space in which the minimum of the cost function is to be found have been defined, the minimum itself can be obtained in step S4 using conventional and well-established principles of variation calculus as described in e.g. T. Englert, A. Völz, F. Mesmer, S. Rhein, K. Graichen: “A software framework for embedded nonlinear model predictive control using a gradient-based augmented Lagrangian approach (GRAMPC)”. In: Optimization and Engineering 20, pp. 769-809, 2019, J. A. E. Andersson, J. Gillis, G. Horn, J. B. Rawlings, M. Diehl: “CasADi-A software framework for nonlinear optimization and optimal control”. In: Mathematical Programming Computation 11(1), pp. 1-36, 2019, H. G. Bock, K. J. Plitt: “A multiple shooting algorithm for direct solution of optimal control problems”. In: Proc. of the IFAC World Congress, pp. 242-247, 1984, M. Diehl, H. G. Bock, H. Diedam, P.-B. Wieber: “Fast Direct Multiple Shooting Algorithms for Optimal Robot Control”. In: Fast Motions in Biomechanics and Robotics Optimization and Feedback Control, ser. Lecture Notes in Control and Information Sciences, K. Mombaur, Ed. Springer-Ver-lag, pp. 65-94, 2006 or J. T. Betts: “A survey of numerical methods for trajectory optimization”. In: Journal of Guidance, Control, and Dynamic, 21, pp. 193-207, 1998.

The steps described above can be carried out offline, with the trajectory thus determined being incorporated in a movement program that is to be repeatedly executed by the robot 1 at a later time. They can also be carried out online, determining e.g. points A and B taking into account where on tray 9 there is a workpiece left to be seized, and where the conveyor happens to have stopped, and determining the trajectory in real time specifically for these points A and B.

### REFERENCE NUMERALS

1 robot
2 base
3 arm
4 end effector
5 operation controller
6 first workpiece
7 conveyor
8 second workpiece
9 tray
10 joint
11 joint
12 sensor
13 wall, barrier
14 opening
15 handover region
16 person

1-14. (canceled)

15. A method for defining a trajectory of a robot for moving along a path from an initial point to a final point in a multidimensional space, each of the initial and final points having a plurality of space coordinates, the space coordinates including position and/or orientation coordinates, wherein the trajectory is a continuous map mapping an initial instant in time to the initial point, a final instant in time to the final point, and intermediate instants in time to intermediate points along the path, the method comprising:
defining a cost function that associates a cost value to a given trajectory:
defining a pluridimensional subspace of the multidimensional space; and
determining a trajectory that minimizes the cost function among trajectories extending along different paths of the subspace, as the trajectory.

16. The method of claim 15, wherein the subspace is the multidimensional space.

17. The method of claim 15, wherein a number of dimensions of the subspace is smaller than a number of dimensions of the multidimensional space.

18. The method of claim 15, wherein the multidimensional space has two position coordinates and the robot comprises a vehicle.

19. The method of claim 15, wherein the multidimensional space has three position coordinates and the robot comprises an end effector.

20. The method of claim 15, wherein the cost function is an increasing function of a time derivative of at least one of the space coordinates, or of a difference between maximum and minimum values assumed by a given coordinate along the given trajectory.

21. The method of claim 20, wherein the at least one of the space coordinates is a speed, an acceleration, or a jerk.

22. The method of claim 15, wherein the step of determining the trajectory that minimizes the cost function is carried out under a constraint for a time derivative of at least one of the space coordinates, or of a difference between maximum and minimum values assumed by a given coordinate along the given trajectory.

23. The method of claim 22, wherein the at least one of the space coordinates is a speed, an acceleration, or a jerk.

24. The method of claim 22, wherein a condition imposed is an upper limit for the time derivative.

25. The method of claim 24, wherein the upper limit is selected so as to keep an amount of energy transferred when the robotic unit, while executing the planned trajectory, collides with a person at rest, at a level deemed to bear no risk of injury to the person.

26. The method of claim 15, wherein a further constraint taken account of in the minimization of the cost function limits a pressing force exercised on a surface by the robotic unit.

27. The method of claim 22, wherein the constraint imposed is a relation between orientation of the robot and a direction of a vector of time derivatives, wherein the vector of time derivatives is perpendicular to a surface of the robotic unit, or a component of the vector of time derivatives is parallel to the surface and is less than a component of the vector perpendicular to the surface, multiplied by a predetermined factor.

28. The method of claim 22, wherein the constraint imposes an upper limit for a load imposed on an actuator driving movement of the robot along the trajectory.

29. The method of claim 15, wherein the cost function is an increasing function of a load imposed on an actuator driving movement of the robot along the trajectory.
